(19) United States
(12) Patent Application Publication
(10) Pub. No.: US 2010/0275788 A1
(43) Pub. Date: Nov. 4, 2010

(54) GRILLING DEVICE

(75) Inventors: Chunyu WU, Fujian Province (CN); Jianyang XU, Fujian Province (CN)

Correspondence Address: RABIN & Berdo, PC, 1101 14TH STREET, NW, SUITE 500, WASHINGTON, DC, 20005, US

(73) Assignee: Tsann Kuen (Zhangzhou) Enterprise Co., Ltd., Fujian Province (CN)

(21) Appl. No.: 12/769,832

(22) Filed: Apr. 29, 2010

(30) Foreign Application Priority Data
Apr. 30, 2009 (CN) 200920138068.0

(51) Int. Cl. A47J 37/06

(52) U.S. Cl. 99/377

(57) ABSTRACT

The present invention provides a grilling device. It comprises two grilling units and a gridiron unit, said two grilling units are rotably connected, said gridiron unit comprises: a fixed seat mounted on one grilling device and disposed with a sliding slot; and a supporting unit slidably connected to the sliding slot and slides between a first position and a second position, the ends of the two second rods extend outside radially to form two cross rods, a fixed rod is fixed between the ends of two cross rods, said two cross rods cooperates with fixed rod to form a supporting platform for steadily supporting the upper grilling unit. Said gridiron shelf is fixed on the bottom of lower grilling unit by the fixed shelf. Because the orientation of said gridiron is precise, the structure is simple and it is convenient to operate, thereby the production and assembly cost will be effectively reduced.

### FIELD OF THE INVENTION

The present invention relates to a grilling device.

### BACKGROUND OF THE INVENTION

The grilling device of the present market, for example as Chinese patent application number ZL02203883.3 published by Chinese patent database, it comprises: a lower grilling seat; a supporting shelf which is U shape and its two ends pivotally connected to the outside of lower grilling seat; an upper grilling seat pivotally mounted in said supporting shelf and locates above said lower grilling seat; two height orientation units for adjusting the space between upper grilling seat and lower grilling seat.

Said supporting shelf comprises a cross rod\two side rods disposed by its side faces, the inner side of said side rod has a depression slot.

Said height orientation unit respectively and symmetrically mounted on the upper grilling seat\lower grilling seat and two sides of the supporting shelf. Said height orientation unit comprises: a fixed position seat; and an upper arm and a lower swing arm pivotally connected vertically. Said fixed position seat is fixed on a side face of said lower grilling seat, and it has at least one orientation slot which has a depression top surface. Said upper swing arm applies its upper part by extending from front to back to pivotally disposed in the depression slot of the inner side of side rod which corresponds to the same side of said orientation seat. Said lower swing arm has an upper part, a central part and a lower part, said upper part stacks and pivotally connected to the lower part of said upper swing arm, said central part corresponds and pivotally connected to the side face of said upper grilling seat, the lower part of said lower swing arm is able to insert and retain into the orientation slot of said orientation seat.

When the lower part of said lower swing arm is operated to locate on said orientation slot, the upper swing arm inserts and retains into an appropriate position of the depression slot of the inner side of side rod of the supporting shelf, then the lower part of lower swing arm is caused to locate on the orientation slot of the fixed position seat, so the supporting height is fixed, further by simultaneously arranging said lower swing arm and the side rod by the same side to pivotally disposed on the side face of the upper grilling seat, the space between said upper grilling seat and said lower grilling seat is fixed.

Although said grilling device can adjust the space between the upper and lower grilling seat, its structure is complex, various kinds of fittings are needed, so the production and assembly would cost high, and it tends to cause dislocation.

### SUMMARY OF THE INVENTION

The objective of the present invention is to provide a grilling device with a simple structure, which is easy to be installed and can be precisely located.

The technical solution applied by the present invention is:

A grilling device, comprises two grilling units rotably connected, it further comprises a gridiron unit, comprising:

a fixed seat mounted on one grilling device and disposed with a sliding slot; and

a supporting unit slidably connected to the sliding slot and slide between a first position and a second position; wherein said supporting unit comprises a first shelf and a second shelf, said second shelf is pivotally connected to the first shelf and rotated between a first angle and a second angle; wherein the pivoting point of said first shelf and said second shelf is in the sliding slot when the supporting unit is in the first position and the second shelf is in the first angle, and the end of said second shelf supports the other grilling unit when the supporting unit is in the second position and the second shelf is in the second angle.

Preferably, said two grilling units are upper grilling unit and lower grilling unit respectively; said fixed seat is mounted on the bottom of the lower grilling unit.

Preferably, one end of said first shelf has an through opening and one end of said second shelf is disposed with a connection sheet which can be inserted into the through opening; said through opening and said connection sheet are connected by a pivot.

Preferably, said first shelf comprises two parallel first column rods; said second shelf comprises two parallel second column rods and the ends of said two second rods extend outside radially to form two cross rods; a fixed rod is fixed between the ends of two cross rods, said two cross rods cooperates with fixed rod to form a supporting platform.

Preferably, the end surface of said connection sheet is an arched surface.

Preferably, the distance of the axis of said pivot and bottom surface of opening is equal or broader than the radius of second column rod.

Preferably, the diameter of said first column rod is equal to that of second column rod.

Preferably, another end of said first column rod has a position restriction piece.

Preferably, said first angle is 0, said second angle is equal or larger than 90°.

The beneficial effects of the present invention is: the pivoting position of the first shelf and second shelf is in the sliding slot when the supporting unit is in the first position and first angle, the end of said second shelf supports another grilling unit when the supporting unit is in the second position and second angle, it has such advantages: 1\said gridiron unit can be firmly fixed on said one grilling unit when the supporting unit is in the first position and first angle; when the supporting unit is in the second position and second angle, the height of upper grilling unit can be raised, so the distance between the upper and lower grilling unit can be precisely fixed, the upper and lower grilling unit can be kept parallel, the food will not be excessfully pressed by the upper grilling unit, and the cleansing problem will be solved; 3\the production fittings will be simplified, and the production and assembly cost will be reduced; 4\the user only need to pull the second shelf and rotate it, then the second shelf will move from the first position and first angle to the second position and second angle, the operation is simple and time-saving.

The pivotal connection of said first and second shelves is by the cooperation of the opening and the connection sheet, so the outer diameter of said pivotal connection is ensured to be equal to the first column rod and second column rod, they can all be adapted to the sliding slot. Because said two cross rods cooperate with the fixed rod to form a supporting platform, so the supporting is steady and firm. Because the end surface of said connection sheet is an arched surface, so the rotating of second shelf will not be affected by the connection sheet. Because the distance between the axis of said pivot and the bottom surface of opening is equal or broader than the radius of second column rod, so the second shelf can be kept at second angle. Said fixed seat is disposed on the bottom surface of the lower grilling unit, so the gridiron unit will not affect the appearance of the grilling device and its assembly space.

### BRIEF DESCRIPTION OF THE DRAWINGS

The present invention will become apparent with reference to the accompanying drawings and the preferred embodiments.

FIG. 1 is the first operating status of the present invention.

FIG. 2 is the exploded view of the gridiron unit of the present invention.

FIG. 3 is the operating status of the gridiron unit of the present invention.

FIG. 4 is the gridiron unit of the present invention, wherein the gridiron unit is under the position restriction status.

FIG. 5 is the second operating status of the present invention.

Legend: upper grilling unit (1)\lower grilling unit (2)\gridiron unit (3)\fixed seat (31)\sliding slot (311)\first shelf (32)\opening (332)\first column rod (323)\second shelf (33)\connection sheet (331)\second column rod (332)\cross rod (333)\fixed rod (334)\pivot (34).

### DETAILED DESCRIPTION OF THE EMBODIMENTS

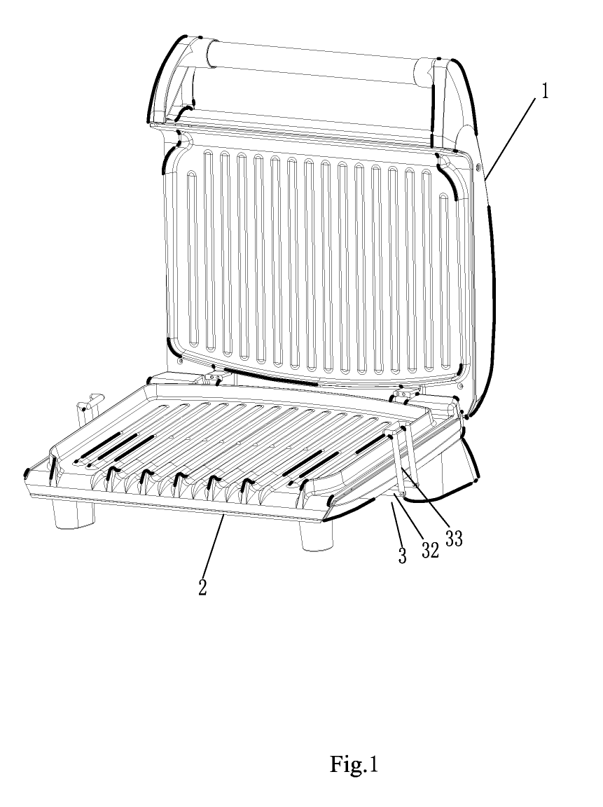

As showed in FIG. 1, the grilling device comprises: an upper grilling unit (1)\a lower grilling unit (2)\a gridiron unit (3). Said upper grilling unit (1) and lower grilling unit (2) are rotably connected.

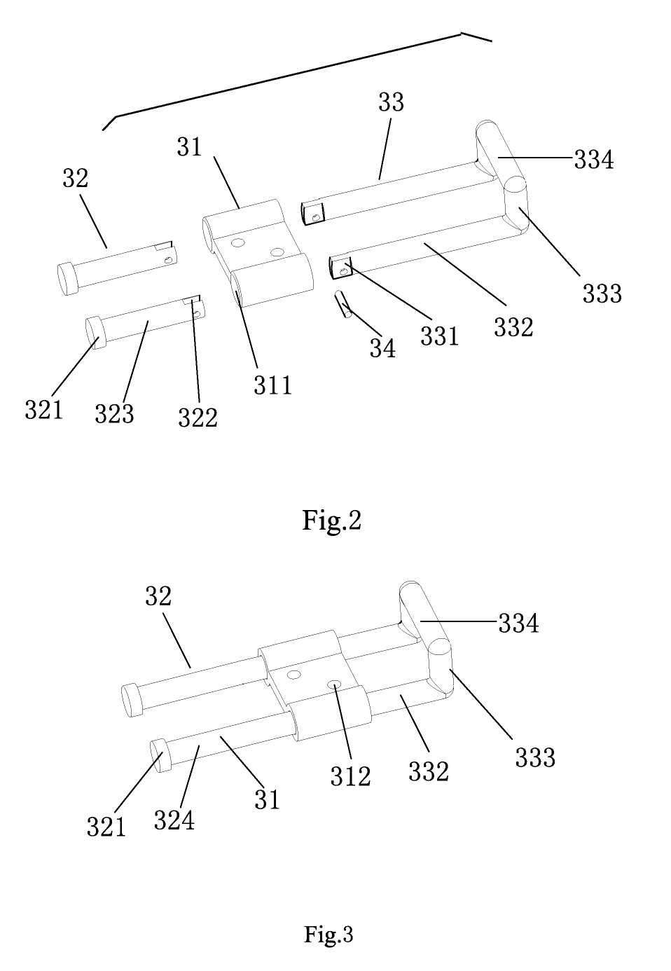

As showed in FIG. 2\FIG. 5, said gridiron unit comprising:

A fixed seat (3) mounted on the lower grilling unit (2), it has:

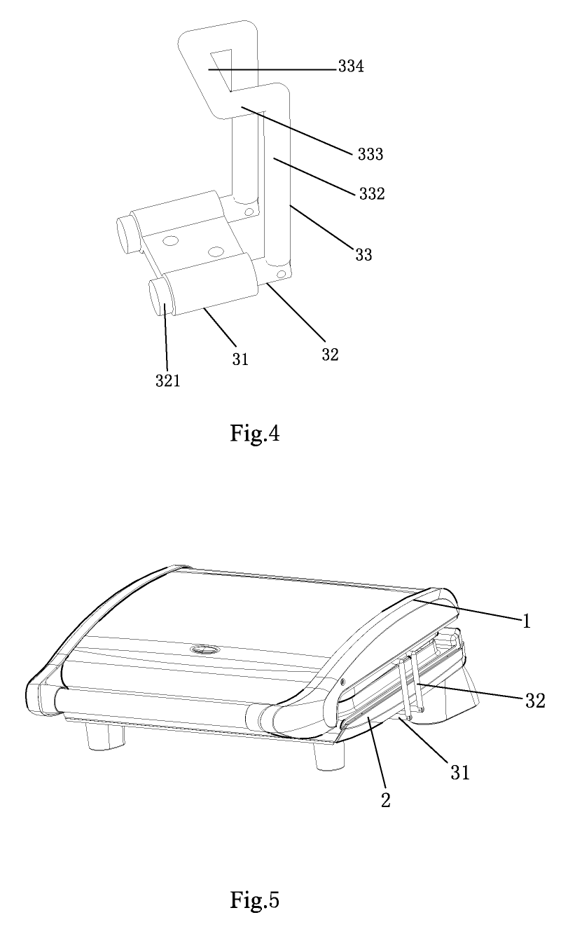

A supporting unit slidably connected to the sliding slot (311) and slides between a first position as showed in FIG. 3 and a second position as showed in FIG. 4, it comprises a first shelf (32) and a second shelf (33), said second shelf (33) is pivotally connected to the first shelf (32) and rotated between a first angle as showed in FIG. 3 and a second angle as showed in FIG. 4, wherein: the pivoting position of the first shelf (32) and second shelf (33) is in the sliding slot (311) when the supporting unit is in the first position and first angle, the end of said second shelf (33) supports grilling unit (1) when the supporting unit is in the second position and second angle. In the present invention, said first angle is 0°, said second angle is equal or larger than 90°.

An end of said first shelf (32) has an through opening (322), an end of said second shelf protrude disposed with a connection sheet (331) which is adapted to the opening, said connection sheet (331) inserts into the opening (322), further a pivot (34) is equipped to connect the opening (322) of said first shelf (32) and the connection sheet (331) of said second shelf (33). In the present invention, the end surface of said connection sheet (331) is an arched surface.

Said first shelf (32) comprises: two parallel first column rods (323), another end of said first column rod (323) has a position restriction block (321); said second shelf (33) comprises: two parallel second column rods (332), the ends of said two second rods (332) extend outside radially to form two cross rods (333), a fixed rod (334) is fixed between the ends of two cross rods, said two cross rods (333) cooperates with fixed rod (334) to form a supporting platform, the diameter of said first column rod (323) is equal to that of second column rod (332). In the present invention, said position restriction block (321) is round, but it is not limited within, said position restriction block (321) can also be elliptical or square.

Although the present invention has been described with reference to the preferred embodiments thereof for carrying out the invention, it is apparent to those skilled in the art that a variety of modifications and changes may be made without departing from the scope of the present invention which is intended to be defined by the appended claims.

What is claimed is:

1. A grilling device, comprises two grilling units rotably connected, characterized in that it further comprises a gridiron unit, comprising:
a fixed seat mounted on one grilling device and disposed with a sliding slot; and
a supporting unit slidably connected to the sliding slot and slide between a first position and a second position; wherein said supporting unit comprises a first shelf and a second shelf, said second shelf is pivotally connected to the first shelf and rotated between a first angle and a second angle; wherein the pivoting point of said first shelf and said second shelf is in the sliding slot when the supporting unit is in the first position and the second shelf is in the first angle, and the end of said second shelf supports the other grilling unit when the supporting unit is in the second position and the second shelf is in the second angle.

2. The grilling device according to claim 1, characterized in that said two grilling units are upper grilling unit and lower grilling unit respectively; said fixed seat is mounted on the bottom of the lower grilling unit.

3. The grilling device according to claim 1, characterized in that one end of said first shelf has an through opening and one end of said second shelf is disposed with a connection sheet which can be inserted into the through opening; said through opening and said connection sheet are connected by a pivot.

4. The grilling device according to claim 3, characterized in that said first shelf comprises two parallel first column rods; said second shelf comprises two parallel second column rods and the ends of said two second rods extend outside radially to form two cross rods; a fixed rod is fixed between the ends of two cross rods, said two cross rods cooperates with fixed rod to form a supporting platform.

5. The grilling device according to claim 3, characterized in that the end surface of said connection sheet is an arched surface.

6. The grilling device according to claim 3, characterized in that the distance of the axis of said pivot and bottom surface of opening is equal or broader than the radius of second column rod.

7. The grilling device according to claim 3, characterized in that the diameter of said first column rod is equal to that of second column rod.

8. The grilling device according to claim 3, characterized in that another end of said first column rod has a position restriction piece.

9. The grilling device according to claim 1, characterized in that said first angle is 0°, said second angle is equal or larger than 90°.

10. The grilling device according to claim 2, characterized in that one end of said first shelf has an through opening and one end of said second shelf is disposed with a connection sheet which can be inserted into the through opening; said through opening and said connection sheet are connected by a pivot.

11. The grilling device according to claim 10, characterized in that said first shelf comprises two parallel first column rods; said second shelf comprises two parallel second column rods and the ends of said two second rods extend outside radially to form two cross rods; a fixed rod is fixed between the ends of two cross rods, said two cross rods cooperates with fixed rod to form a supporting platform.

12. The grilling device according to claim 10, characterized in that the end surface of said connection sheet is an arched surface.

13. The grilling device according to claim 10, characterized in that the distance of the axis of said pivot and bottom surface of opening is equal or broader than the radius of second column rod.

14. The grilling device according to claim 10, characterized in that the diameter of said first column rod is equal to that of second column rod.

15. The grilling device according to claim 10, characterized in that another end of said first column rod has a position restriction piece.
